(19) United States
(12) Patent Application Publication
(10) Pub. No.: US 2008/0264706 A1
(43) Pub. Date: Oct. 30, 2008

(54) Force Transmitting System for a Hybrid Driven Motor Vehicle

(76) Inventor: Roland Andersson, Sollebrunn (SE)

Correspondence Address: HARNESS, DICKEY & PIERCE, P.L.C., P.O. BOX 8910, RESTON, VA, 20195, US

(21) Appl. No.: 11/631,661

(22) PCT Filed: Jul. 4, 2005
(86) PCT No.: PCT/SE05/01099

§ 371 Date: Jan. 29, 2008

(30) Foreign Application Priority Data
Jul. 9, 2004 (SE) 0401827-1

(51) Int. Cl. B60K 6/20

(52) U.S. Cl. 180/65.6; 903/902; 903/912; 903/915

(57) ABSTRACT

A power transmission system for a hybrid motor vehicle is disclosed, where the vehicle is alternatively drivable via one or the other of two motors which are independent of one another, in particular an internal combustion engine and an electric motor, or by combined operation of these motors. The system includes an input shaft connected to the internal combustion engine, which shaft can, via a clutch arrangement, on the one hand transmit rotation of the input shaft to an output shaft, which is connected to a transmission of the vehicle, and on the other hand transmit rotation of the electric motor to the output shaft. The electric motor includes an annular stator and an annular rotor, which are arranged in a common radial plane and coaxially with the output shaft, the clutch arrangement including a first clutch unit, which is arranged so as to be capable of transmitting rotation from the rotor of the electric motor to the output shaft, and a second clutch unit, which is arranged so as to be capable of transmitting rotation of the input shaft to the output shaft via the rotor of the electric motor and the first clutch unit.

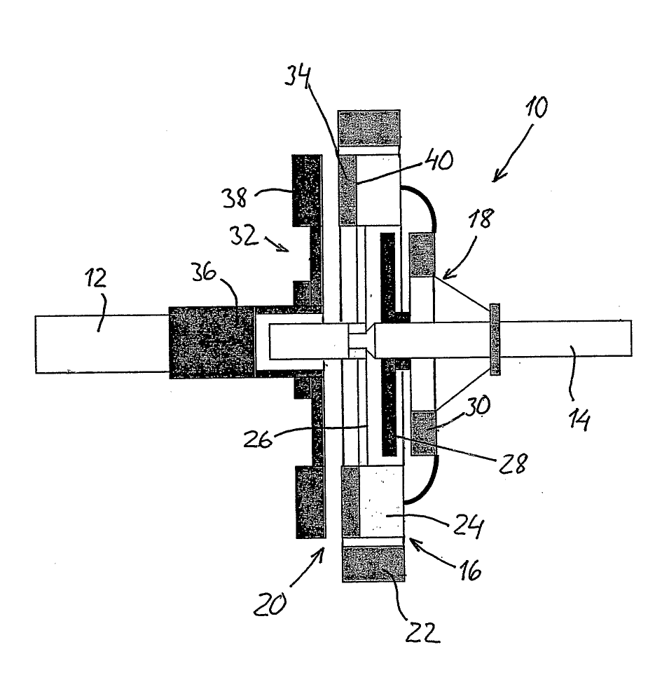

### BACKGROUND OF THE INVENTION

1. Technical Field

The present invention relates to a power transmission system for a hybrid motor vehicle, where the vehicle is alternatively drivable by means of one or the other of two motors which are independent of one another, in particular an internal combustion engine and an electric motor, or by combined operation of these motors, the system having an input shaft connected to the internal combustion engine, which shaft can, via a clutch arrangement, on the one hand transmit rotation of the input shaft to an output shaft, which is connected to a transmission of the vehicle, and on the other hand transmit rotation of the electric motor to the output shaft.

2. Prior Art

It has hitherto not been possible to integrate known clutch arrangements for hybrid vehicles with combined electric motor and internal combustion engine drive in a compact way in the interface between the internal combustion engine and the transmission of the vehicle.

### SUMMARY OF THE INVENTION

The object of the invention is to propose a power transmission system for a hybrid vehicle which eliminates the abovementioned disadvantage of previously known systems and where two clutch units and the electric motor can be assembled to form a very compact unit which creates an opportunity for simplified installation of the system in a motor vehicle of the hybrid type without the body having to be modified. For this purpose, the system according to the invention referred to in the introduction is characterized in that the electric motor comprises an annular stator and an annular rotor, which are arranged in a common radial plane and coaxially with the input shaft, the clutch arrangement comprising a first clutch unit, which is arranged so as to be capable of transmitting rotation from the rotor of the electric motor to the output shaft, and a second clutch unit, which is arranged so as to be capable of transmitting rotation of the input shaft to the output shaft via the rotor of the electric motor and the first clutch unit.

Further features and advantages of the system according to the invention will emerge from the dependent patent claims and from the detailed description below of a preferred embodiment of the invention with reference to the accompanying drawing.

### BRIEF DESCRIPTION OF THE DRAWING

The drawing FIGURE shows diagrammatically in side view the fundamental construction of the power transmission system according to the invention.

### DETAILED DESCRIPTION OF PREFERRED EMBODIMENT

In the figure, a power transmission system according to the invention for a hybrid vehicle of the kind which comprises an internal combustion engine and an electric motor, where the vehicle is to be capable of being driven only by the internal combustion engine or only by the electric motor, or in combined, joint operation for maximum performance, is designated generally by 10. Fundamentally, the system 10 comprises an input shaft 12 from an internal combustion engine (not shown), an output shaft 14 to a transmission (not shown), an electric motor 16, located between the shafts 12 and 14, and a clutch arrangement in the form of a first clutch unit 18, located between the electric motor 16 and the output shaft 14, and a second clutch unit 20, located between the input shaft 12 and the electric motor 16. The electric motor 16 comprises a radially outer, annular stator 22 and a rotor 24 located radially inside the stator 22. The rotor 24 has a hub disk 26, which is mounted freely rotatably on an end portion of the output shaft 14, which in turn is located coaxially relative to the input shaft 12 from the internal combustion engine and mounted rotatably in the end of this shaft. The electric motor 16 is therefore located coaxially with the input and output shafts 12, 14.

In the example shown, the first clutch unit 18 for alternative rotation transmission between the rotor 24 of the electric motor 16 and the output shaft 14 comprises a clutch disk 28, which, by means of splines or equivalent, is connected in a rotationally fixed way to the shaft 14 and displaceable on it, and a pressure element 30 in the form of an annular disk, for example, which is axially displaceable on the shaft 14 and can cause the clutch disk 28 to be pressed hard against the hub disk 26 of the rotor 24 in order thus to create a power-transmitting friction joint between the rotor 24 and the output shaft 14.

In order to transmit rotating driving power from the internal combustion engine to the output shaft 14 connected to the transmission, the second clutch unit 20 of the clutch arrangement is arranged so as first to transmit the rotation of the shaft 12 to the rotor 24 of the electric motor 16, which is thus driven with the rotation of the shaft 12 and can in turn, via the first clutch unit 18 described above, convey the rotation on to the output shaft 14. For this purpose, the second clutch unit 20 preferably comprises an electromagnetic clutch, which has a first clutch half 32 connected to the input shaft 12, and a second clutch half 34 connected integrally to the rotor 24. The first clutch half 32 is designed as a flywheel with on the one hand a hub part 36, which engages with the input shaft 12 via splines, and on the other hand a peripheral part 38, which is arranged so as to be capable of being brought into and out of engagement with the second clutch half 34. The second clutch half 34 is connected firmly to an axial side 40 of the rotor 24.

When the output shaft 14 is driven from the internal combustion engine, the first and second clutch units 18, 20 are therefore coupled to one another in series with the rotor 24 of the electric motor 16 connected as a driver between them. If so desired, the electric motor 16 can also be activated at the same time in order to provide additional power to the output shaft 12. When the output shaft 14 is driven purely electrically, the second, electromagnetic clutch unit 20 remains inactivated (disengaged), and the first clutch unit 18 is activated.

The clutch units 18 and 20 can therefore be activated at the same time in order to bring about either only internal combustion engine drive or combined electric motor and internal combustion engine drive, or the second clutch unit 20 remains inactive and the coupling unit 18 is active for purely electric drive. The latter type of operation is suitable in particular for the starting cycle of the vehicle as it affords environmental advantages and better fuel economy. The electric motor 16 can be of the FAS (Flywheel Alternator System) type and also allow charging of the batteries (not shown), which supply power to the electric motor 16, when braking takes place. The electric motor 16 then acts as a generator.

Although the clutch units 18, 20 have been exemplified above as an electromagnetic clutch and a clutch of the disk type respectively, it is possible within the scope of the invention to use only electromechanical, hydraulic or mechanical clutches or suitable combinations of these. It is therefore possible to design the first clutch unit 18 as a hydraulic clutch unit (torque converter type) integrated in an automatic transmission.

1. A power transmission system for a hybrid motor vehicle, where the vehicle is alternatively drivable via one or the other of two motors which are independent of one another or by combined operation of these motors, the system comprising:
an input shaft connected to the internal combustion engine, the shaft being adapted to, via a clutch arrangement, transmit rotation of the input shaft to an output shaft, connected to a transmission of the vehicle, and to transmit rotation of the electric motor to the output shaft, the electric motor including an annular stator and an annular rotor, arranged in a common radial plane and coaxially with the output shaft, the clutch arrangement including a first clutch unity arranged to transmit rotation from the rotor of the electric motor to the output shaft, and a second clutch unit, arranged to transmit rotation of the input shaft to the output shaft via the rotor of the electric motor and the first clutch unit.

2. The system as claimed in claim 1, wherein at least one of the clutch units is designed as a mechanical clutch.

3. the system as claimed in claim 1, wherein at least one of the clutch units is designed as a hydraulic clutch.

4. The system as claimed in claim 1, wherein at least one of the clutch units is designed as an electromagnetic clutch.

5. The system as claimed in claim 1, wherein said second clutch unit consists of an electromagnetic clutch, including a first clutch half connected to the input shaft, and a second clutch half connected integrally to the rotor.

6. The system as claimed in claim 5, wherein the first clutch half is rotationally fixed and axially movable relative to the input shaft.

7. The system as claimed in claim 6, wherein the first clutch half (is designed as a flywheel with a hub part, which engages with the input shaft via splines, and a peripheral part, which is arranged to be brought into and out of engagement with the second clutch half.

8. The system as claimed in claim 5, wherein the second clutch half is connected firmly to an axial side of the rotor.

9. The system as claimed in claim 1, wherein the first clutch unit comprises a hub disk integrated with the rotor, the hub disk being mounted freely rotatably on the output shaft, a clutch disk mounted in a rotationally fixed way but displaceably on the output shaft, and a pressure element arranged coaxially with the hub disk and the clutch disk, the pressure element being displaceable along the output shaft for force-closed pressing together with the hub and clutch disks.

10. The system as claimed in claim 1, wherein one end of the output shaft is mounted freely rotatably in an end portion of the input shaft.

11. The system as claimed in claim 2, wherein said second clutch unit consists of an electromagnetic clutch, including a first clutch half connected to the input shaft, and a second clutch half connected integrally to the rotor.

12. The system as claimed in claim 3, wherein said second clutch unit consists of an electromagnetic clutch, including a first clutch half connected to the input shaft, and a second clutch half connected integrally to the rotor.

13. The system as claimed in claim 4, wherein said second clutch unit consists of an electromagnetic clutch, including a first clutch half connected to the input shaft, and a second clutch half connected integrally to the rotor.

14. The system as claimed in claim 6, wherein the second clutch half is connected firmly to an axial side of the rotor.

15. The system as claimed in claim 2, wherein the first clutch unit comprises a hub disk integrated with the rotor, the hub disk being mounted freely rotatably on the output shaft, a clutch disk mounted in a rotationally fixed way but displaceably on the output shaft, and a pressure element arranged coaxially with the hub disk and the clutch disk, the pressure element being displaceable along the output shaft for force-closed pressing together with the hub and clutch disks.

16. The system as claimed in claim 2, wherein one end of the output shaft is mounted freely rotatably in an end portion of the input shaft.
